(19) United States
(12) Patent Application Publication
(10) Pub. No.: US 2015/0332215 A1
(43) Pub. Date: Nov. 19, 2015

(54) FOOD DELIVERY SERVICE AND INSURANCE SYSTEMS

(71) Applicant: Allstate Insurance Company, Northbrook, IL (US)

(72) Inventors: Thomas J. Wilson, Chicago, IL (US); Edward A. Biemer, Glencoe, IL (US)

(73) Assignee: Allstate Insurance Company, Northbrook, IL (US)

(21) Appl. No.: 14/215,690

(22) Filed: Mar. 17, 2014

(51) Int. Cl. G06Q 10/08; G06Q 30/02

(52) U.S. Cl. CPC G06Q 10/0832; G06Q 40/08; G06Q 30/0207

(57) ABSTRACT

Aspects of the disclosure provide a computer-implemented-method and system for providing a food delivery service to a person's residence. To execute these methods, the delivery system may utilize (a) information regarding the location of a person ordering food from a restaurant or a food orderer, (b) the location of the restaurant, and (c) the location of potential third party delivery agents. These food delivery service systems may include restaurants of any type or food and/or retail food stores, such as grocery stores, pharmacies, drug stores, retail stores, discount retail stores, etc. The food delivery service systems may further utilize historical information and/or insurance information to enhance the food delivery services.

### FIELD OF THE INVENTION

The disclosure relates generally to third party food delivery services and insurance systems. More specifically, the disclosure provides computer-implemented methods and systems for providing a system for a third party food delivery service utilizing one or both of insurance information or historical information.

### BACKGROUND

Third party delivery services generally offer delivering of goods and/or merchandise. For example, third party delivery services may provide people to deliver goods and/or merchandise from a retailer to a buyer of those goods and/or merchandise. One such retailer may be food retail, for example grocery stores, restaurants, or other retail food stores. Some restaurants, grocery stores, or other retail food stores do not have delivery services. There is a need for methods and/or systems to provide third party delivery services for those restaurants, grocery stores, or other retail food stores. Additionally, there is a vast wealth of historical information and insurance information that includes customer information, insured information, locations and instances for previous accidents and previous insurance claims.

Accordingly, it would be desirable to provide a system and method that uses information regarding the location of a person ordering food from a restaurant, the location of the restaurant, and the location of potential third party delivery agents to determine and execute an approach for the delivery of food to a person's home. Additionally, insurance information regarding the potential third party delivery agents, such as insurance type, address, and other available insurance information may be utilized to enhance the delivery system. Additionally, it would be desirable to provide a delivery service system that allows for third parties to contract for a particular delivery in exchange for money from the person ordering the food or the restaurant. Additionally, it would be desirable to integrate the vast wealth of insurance information regarding accidents and claims to further enhance the third party delivery methods and systems by providing safe routes for the deliveries.

### BRIEF SUMMARY

The following presents a simplified summary of the invention in order to provide a basic understanding of some aspects of the invention. This summary is not an extensive overview of the invention. It is not intended to identify key or critical elements of the invention or to delineate the scope of the invention. The following summary merely presents some concepts of the invention in a simplified form as a prelude to the more detailed description provided below.

An aspect of the disclosure provides a computer-implemented method of providing an food delivery service and insurance system. The method may comprise: receiving, by a delivery server, a food delivery request, wherein the food delivery request is a food order configured from a person ordering food; (2) receiving, by the delivery server, a set of historical information about the food orderer and a set of potential delivery agents to fulfill the food delivery request; (3) providing, by the delivery server, a prioritized ranking of the set of potential delivery agents capable of fulfilling the food delivery; (4) determining, by the delivery server, a delivery agent from the set of potential delivery agents by analyzing the food delivery request, the set of historical information about the food orderer and the set of historical information about the set of potential delivery agents; (5) utilizing, by the delivery server, the set of historical information and determining a safe route based on the set of historical information of the delivery for the delivery agent; and (6) providing, by the delivery server, a reward to one or both of the delivery agent and the person ordering the food.

Another aspect of the disclosure provides a computer-implemented method of providing an food delivery service and insurance system. The method may comprise: receiving, by a delivery server, a food delivery request, wherein the food delivery request is a food order configured from a person ordering food; (2) receiving, by the delivery server, a set of insurance information about the food orderer and a set of potential delivery agents to fulfill the food delivery request; (3) providing, by the delivery server, a prioritized ranking of the set of potential delivery agents capable of fulfilling the food delivery; (4) determining, by the delivery server, a delivery agent from the set of potential delivery agents by analyzing the food delivery request, the set of insurance information about the food orderer and the set of insurance information about the set of potential delivery agents; (5) utilizing, by the delivery server, the set of insurance information and determining a safe route based on the set of insurance information of the delivery for the delivery agent; and (6) providing, by the delivery server, a reward to one or both of the delivery agent and the person ordering the food.

The details of these and other embodiments of the present disclosure are set forth in the accompanying drawings and the description below. Other features and advantages of the disclosure will be apparent form the description and drawings.

### BRIEF DESCRIPTION OF THE DRAWINGS

A more complete understanding of the present invention and the advantages thereof may be acquired by referring to the following description in consideration of the accompanying drawings, in which like reference numbers indicate like features, and wherein:

FIG. 1 is an illustrative operating environment in which various aspects of the disclosure may be implemented;

FIG. 2 is an illustrative block diagram of workstations and servers that may be used to implement the processes and functions of certain aspects of the present disclosure;

FIG. 3 illustrates an exemplary workflow diagram that may be used to implement various aspects of the disclosure; and

FIG. 4 illustrates a method of providing a food delivery service and insurance system in accordance with aspects of this invention.

### DETAILED DESCRIPTION

In the following description of the various embodiments, reference is made to the accompanying drawings, which form a part hereof, and in which is shown by way of illustration various embodiments in which the invention may be practiced. It is to be understood that other embodiments may be utilized and structural and functional modifications may be made without departing from the scope of the present invention.

Aspects of the disclosure provide a computer-implemented-method and system for providing a food delivery service to a person's residence. To execute these methods, the delivery system may utilize (a) information regarding the location of a person ordering food from a restaurant or a food orderer, (b) the location of the restaurant, and (c) the location of potential third party delivery agents. These food delivery services may include restaurants of any type or food and/or retail food stores, such as grocery stores, pharmacies, drug stores, retail stores, discount retail stores, etc. The potential third party delivery agents may include other customers at the restaurant. These other customers may have a set of historical information and/or a set of insurance information associated with each customer. As some restaurants do not have delivery services, this system allows for third parties to contract for particular delivery in exchange for money or other rewards. The food orderer may pay for this third party delivery service. In another embodiment, the restaurant may also pay or provide a portion of the payment for this third party delivery service.

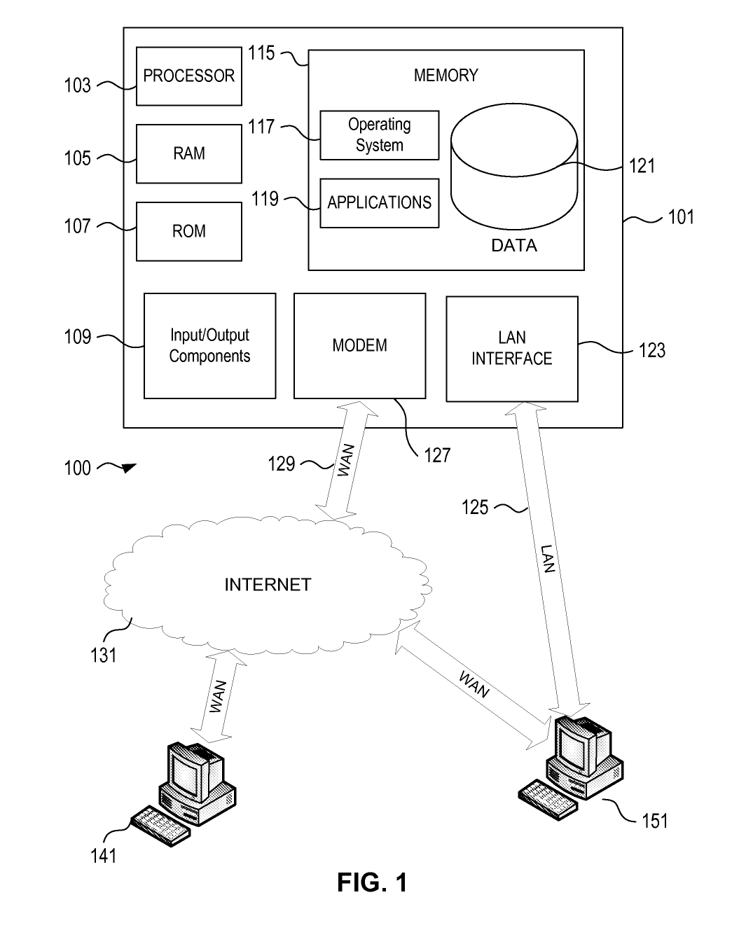

FIG. 1 illustrates a block diagram of a delivery server 101 (e.g., a computer server) in communication with a delivery system 100 that may be used according to an illustrative embodiment of the disclosure. The delivery server 101 may have a processor 103 for controlling overall operation of the delivery server 101 and its associated components, including RAM 105, ROM 107, input/output component 109, and memory 115.

I/O 109 may include a microphone, keypad, touch screen, and/or stylus through which a user of the delivery server 101 may provide input, and may also include one or more of a speaker for providing audio output and a video display device for providing textual, audiovisual and/or graphical output. Software may be stored within memory 115 and/or storage to provide instructions to processor 103 for enabling the delivery server 101 to perform various functions. For example, the memory 115 may store software used by the delivery server 101, such as an operating system 117, application programs 119, and an associated database 121.

The delivery server 101 may operate in a networked environment supporting connections to one or more remote computers, such as terminals 141 and 151. The terminals 141 and 151 may be personal computers or servers that include many or all of the elements described above relative to the delivery server 101. Alternatively, terminal 141 and/or 151 may be data stores for storing information related to a community member's contacts. The network connections depicted in FIG. 1 include a local area network (LAN) 125 and a wide area network (WAN) 129 but may also include other networks. When used in a LAN networking environment, the delivery server 101 is connected to the LAN 125 through a network interface or adapter 123. When used in a WAN networking environment, the delivery server 101 may include a modem 127 or other means for establishing communications over the WAN 129, such as the Internet 131. It will be appreciated that the network connections shown are illustrative and other means of establishing a communications link between the computers may be used. The existence of any of various well-known protocols such as TCP/IP, Ethernet, FTP, HTTP and the like is presumed.

Additionally, an application program 119 used by the delivery server 101 according to an illustrative embodiment of the disclosure may include computer executable instructions for invoking functionality related to food delivery service and insurance systems. The delivery server 101 and/or terminals 141 or 151 may also be mobile terminals including various other components, such as a battery, speaker, and antennas (not shown).

The disclosure is operational with numerous other general purpose or special purpose computing system environments or configurations. Examples of well known computing systems, environments, and/or configurations that may be suitable for use with the disclosure include, but are not limited to, personal computers, server computers, hand-held or laptop devices, mobile devices, multiprocessor systems, microprocessor-based systems, set top boxes, programmable consumer electronics, network PCs, minicomputers, mainframe computers, and distributed computing environments that include any of the above systems or devices, and the like.

The disclosure may be described in the general context of computer-executable instructions, such as program applications or modules, being executed by a computer. Generally, program applications or modules include routines, programs, objects, components, data structures, etc. that perform particular tasks or implement particular abstract data types. The disclosure may also be practiced in distributed computing environments where tasks are performed by remote processing devices that are linked through a communications network. In a distributed computing environment, the program applications or modules may be located in both local and remote computer storage media including memory storage devices.

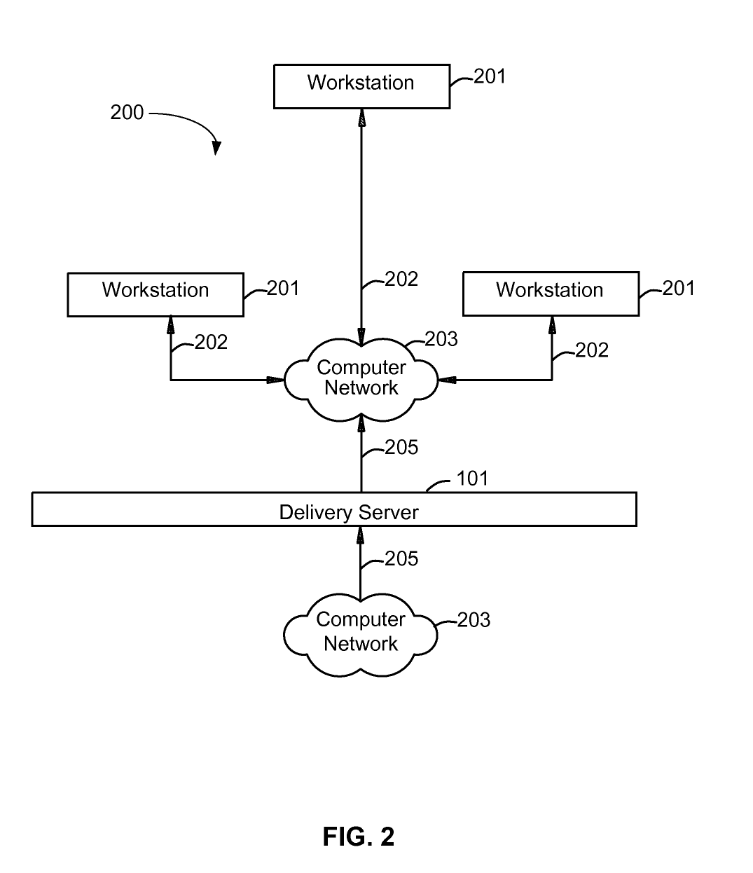

Referring to FIG. 2, an illustrative system 200 for implementing methods according to the present disclosure is shown. As illustrated, the system 200 may include one or more workstations/servers 201. The workstations 201 may be local or remote, and are connected by one or more communications links 202 to the computer network 203 that is linked via communications links 205 to enhance the delivery server 101. In certain embodiments, workstations 201 may run different algorithms used by the delivery server 101 for generating and providing a delivery order, or, in other embodiments, workstations 201 may be different points at which the delivery server 101 may be accessed. In the system 200, the delivery server 101 may be any suitable server, processor, computer, or data processing device, or combination of the same. The delivery server 101 may by located or connected to an insurance company or an insurance company server. In another embodiment without departing from this invention, the delivery server 101 may be a stand-alone server.

The computer network 203 may be any suitable computer network including the Internet, an intranet, a wide-area network (WAN), a local-area network (LAN), a wireless network, a digital subscriber line (DSL) network, a frame relay network, an asynchronous transfer mode (ATM) network, a virtual private network (VPN), or any combination of any of the same. The communications links 202 and 205 may be any communications links suitable for communicating between the workstations 201 and the delivery server 101, such as network links, dial-up links, wireless links, hard-wired links, etc.

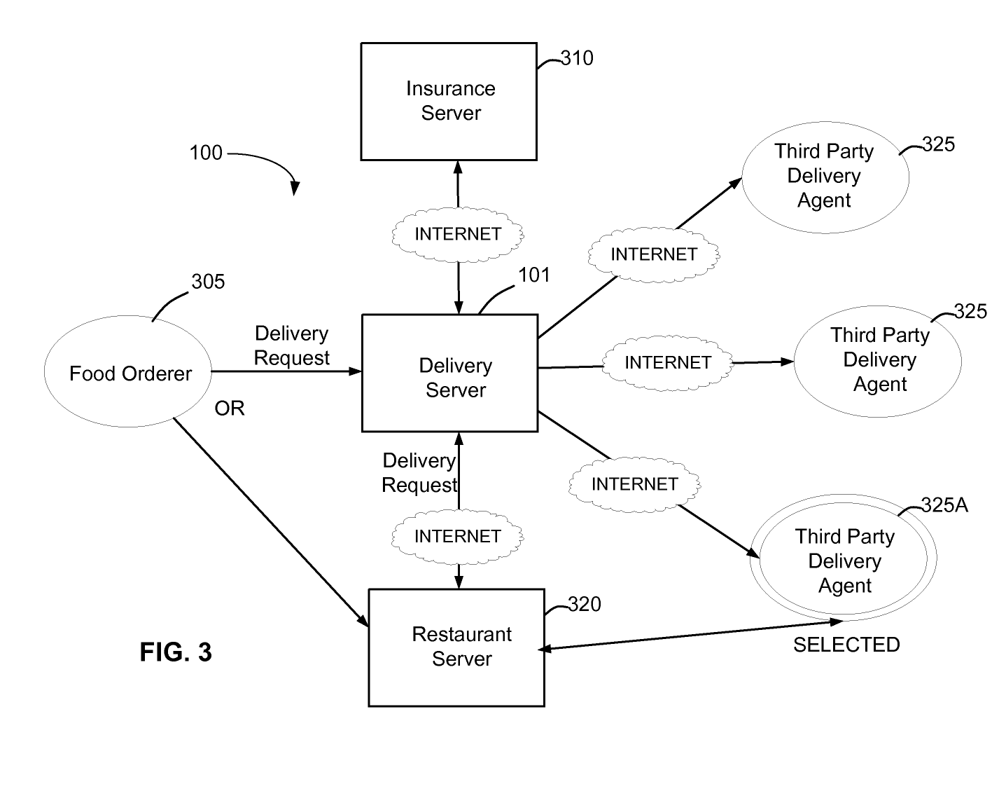

Referring to FIG. 3, an illustrative flow diagram for an exemplary third party food delivery system 100 is shown. The exemplary third party food delivery system 100 may include a delivery server 101. The exemplary third party system 100 may also include an insurance server 310 and a restaurant server 320. The exemplary third party system 100 may also include a food orderer 305 or a person who orders the food and one or more third party delivery agents 325.

As illustrated in FIG. 3, a food orderer 305 may provide a delivery request to a delivery server 101 in one of two different methods. A first method may be directly to the delivery server 101. A second method may be from the food orderer 305 to the restaurant and then to the delivery server 101. This delivery request may be an order for food or something similar. When the food orderer 305 provides the delivery request to the delivery server 101 directly, the delivery request may be transmitted or sent to the delivery server 101 in any available means known and used in the art. For example, the delivery request may be sent to the delivery server 101 via telephone, email, text, web-based ordering, software application on a mobile device, or any other transmission methods without departing from this invention.

When the food orderer 305 provides the delivery request to the restaurant, the food orderer 305 may order the food through the restaurant. The food orderer 305 may order the food by any available means known and used in the art. For example, the food orderer 305 may order the food via telephone, email, text, web-based ordering, software application on a mobile device or any other ordering methods without departing from this invention. The selected restaurant may have a restaurant server 320 or processor that communicates with the delivery server 101 and the delivery system 100. The selected restaurant may require the necessary hardware and/or software to communicate with the delivery server 101 and the delivery system 100. After the food orderer 305 orders the food through the restaurant, the food order is entered and/or processed through the restaurant server 320 into a delivery request. The delivery request may then be transferred to the delivery server 101. It will be appreciated that the internet/network connections shown are illustrative and other means of establishing a communications link between the servers and/or computers that may be used. The existence of any of various well-known protocols such as TCP/IP, Ethernet, FTP, HTTP and the like is presumed.

The delivery server 101 may utilize historical information and/or insurance information to provide further information regarding the delivery. The historical information and insurance information may include customer information, insured information, locations and instances for previous accidents and previous insurance claims. The delivery server 101 may also utilize specific insurance information which may be received from an insurance server 310. The insurance server 310 may reside on an insurance server 310 at an insurance company. The insurance server 310 may include insurance information about a particular user, previous accidents, previous claims, information about other users with similar characteristics, etc.

The delivery server 101 may then communicate with various potential delivery agents 325 that may be capable of fulfilling the specific delivery request. A delivery agent 325 that meets the requirements and accepts the delivery request may then be selected and become the selected delivery agent 325A. The delivery agent 325 may communicate through the delivery server 101 their availability and acceptance of the delivery request. The selected delivery agent 325A may also communicate with the restaurant server 320 througout the delivery. The selected delivery agent 325A may then pick up the food and deliver the food to the food orderer 305 to meet the delivery request.

Aspects of the disclosure provide a computer-implemented-method and system for providing a food delivery service to a person's residence. To execute these methods, the delivery system may utilize (a) information regarding the location of a person ordering food from a restaurant or food orderer, (b) the location of the restaurant, and (c) the location of potential third party delivery agents. These food delivery services may include restaurants of any type or food and/or retail food stores, such as grocery stores, pharmacies, drug stores, retail stores, discount retail stores, etc. The potential third party delivery agents may include other customers at the restaurant. These other customers may have a set of historical information and/or a set of insurance information associated with each customer. As some restaurants do not have delivery services, this system allows for third parties to contract for particular delivery in exchange for money or other rewards. The food orderer may pay for this third party delivery service. In another embodiment, the restaurant may also pay or provide a portion of the payment for this third party delivery service.

Further aspects of the disclosure provide that the delivery system and methods can utilize historical and/or insurance information regarding the food orderer and third parties to help manage the delivery of the food. The delivery system may determine and analyze the information that may include: the type of insurance of the third party delivery agent, the primary address of the third party delivery agent, and/or the address for the delivery (the address of the food orderer). The delivery system may allocate the delivery duties to a third party delivery agent who may get paid by (1) directly by the food orderer, or (2) the restaurant or food store/grocery store, or (3) the insurance company.

Further aspects of the disclosure provide that the delivery system and methods can determine the location of the nearest group of potential third party delivery agents to the restaurant of choice and the home address for those potential third party delivery agents (assuming the third party delivery agents are not at home at the time. The delivery system may also determine and/or know the address of the food orderer. Based on this information, the delivery system may then ask or inquire whether any of those potential third party delivery agents are willing to deliver food to the food orderer.

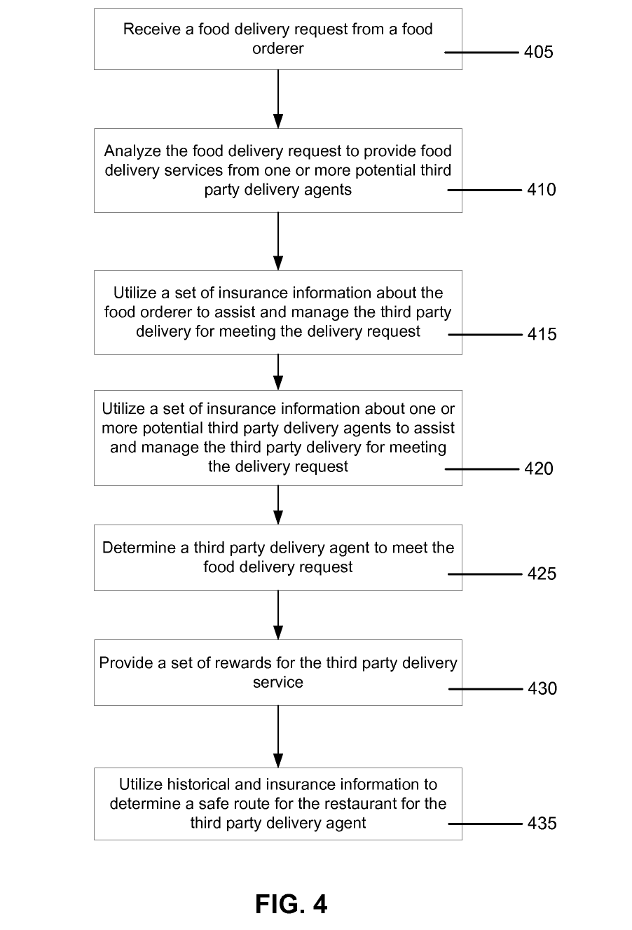

The steps that follow in FIG. 4 may be implemented by one or more of the components in FIGS. 1 through 3 and/or other components, including other computing devices. FIG. 4 illustrates an example process 400 by which a user may utilize a computer-implemented method and system for food delivery service and insurance systems.

In step 405, the delivery system may receive a delivery request. The delivery request may be received from a restaurant. The restaurant may send the delivery request through any means and methods known and used in the art, such as via the internet. This delivery request may also come directly from a food orderer, such that the request goes to the delivery system or delivery server first and then the order is communicated or sent to the restaurant for further processing.

In step 410, the delivery system may analyze the delivery request to provide food delivery services from third parties who may deliver food to another party based on a set of parameters. For example, the set of parameters may include information regarding the location of a person ordering food from a restaurant. The set of parameters may also include the location of the restaurant. The set of parameters may also include the location of existing and/or other insurance customers at the restaurant.

In step 415, the delivery system may use a set of historical and/or insurance information about the food orderer to assist and manage the third party delivery in meeting the delivery request. Generally, the historical information and insurance information may include customer information, insured information, locations and instances for previous accidents and previous insurance claims. The set of historical and/or insurance information may include type of insurance and the primary address of the food orderer. The system may utilize the set of historical and/or insurance information about the food orderer to allocate delivery duties to a third party delivery agent who is an insured member based on the set of historical and/or insurance information. Additionally, the system may utilize the set of historical and/or information about the food orderer to inquire whether any potential third party delivery agents who are insured members are willing to deliver to the food order and fulfill the food delivery request. The system may also utilize the set of historical and/or insurance information about the food orderer to pre-determine a list of restaurants from which third party delivery agents currently are willing to deliver food to the food orderer. The system may also utilize the set of historical and/or insurance information about the food orderer to match residences of the potential third party delivery agent with the residence of the food orderer.

In step 420, the delivery system may use a set of historical and/or insurance information about one or more of the potential third party delivery agents to assist and manage the third party delivery in meeting the delivery request. Generally, the historical information and insurance information may include customer information, insured information, locations and instances for previous accidents and previous insurance claims. The set of historical and/or insurance information may include type of insurance and the primary address of the potential third party delivery agent. The system may utilize the set of historical and/or insurance information about the potential third party delivery agent to determine a list of potential third party delivery agents for a given food delivery. The system may also utilize the set of historical and/or insurance information about the potential third party delivery agent to pre-determine a list of potential third party delivery agents for a given restaurant by matching the location of the restaurant and the residence of the potential third party delivery agents.

In step 425, the delivery system may determine the third party delivery agent to meet the delivery request. The delivery system may prioritize the third party delivery agents in determining the third party delivery agent to meet the delivery request. The delivery system may allow third parties to contract for a particular delivery in exchange for money. The money may be exchanged from the food orderer or from the restaurant.

In step 430, the delivery system may provide rewards for the delivery service. The rewards may also include cash back, a reward at the restaurant, a discount at the restaurant, and/or a bonus food item. The delivery system may also provide rewards such as insurance rewards or free insurance. Additionally, the rewards may also include discounts on future premiums, increased insurance coverages, and/or decreased deductible. The reward may be provided to the third party delivery agent following the delivering of the food and meeting the delivery request. The reward may also be provided to the food orderer.

In step 435, the delivery system may utilize historical information and/or insurance information to determine a safe route for a potential restaurant for the third party delivery agent. Based on the historical information and/or insurance information, the delivery system may know where the third party delivery agent is currently located and provide the safest route and/or a prioritized list of those restaurants and/or the residence of the food orderer. The delivery system may further utilize the historical and/or insurance information such as previous accident locations and/or insurance claims to assist in selecting the safest route to the restaurant and/or the residence of the food orderer. The delivery system may provide recommendations for the safest routes and rate the routes and the restaurants based on the previous accidents and claims in the historical and/or insurance information.

In another aspect of the disclosure, the delivery system may pre-determine a list of restaurants from which the third party delivery agents currently are willing to drive food to the people who order the food. The delivery system may match together residences of the potential third party delivery agent with the residence of the food orderer. The delivery system may also rank the restaurants with respect to options and the timeliness of the food preparation and/or the food delivery.

In yet another aspect of the disclosure, the delivery system may further keep track of the food ordered and the management of the food ordering process. The delivery system may utilize that information in deriving insurance rating factors to set or revise premiums for insurance coverage. For example, the delivery system may keep track and analyze which restaurants the person orders from, the locations of those restaurants, when the user orders food, and the type of food ordered, the frequency of orders, etc. Based on the analysis of these orders and this information among millions of users, the system may derive rating factors from the information. For example, people that order from a restaurant near the highway more than twice a week on average may be subject to a particular rating factor (either increase or decrease the premium for insurance coverages). Many other variables and rating factors may be utilized with this order information, without departing from this disclosure.

In another aspect of the disclosure, the delivery system may include a means for authentication of the potential third party delivery agents delivering the food. For example, the delivery system may provide the food orderer information about the third party delivery agent, such as safety information, safety rating, delivery rating, etc. The delivery system may also provide a means for vouching that the third party delivery agent has a certain level of insurance with the insurance company. The delivery system may also provide insurance to the food orderer should the third party delivery agent do something improper.

In yet another aspect of the disclosure, general aspects of insurance and/or insurance information may augment and/or supplement the delivery system. In one exemplary embodiment, insurance rating factors may be utilized to augment and/or supplement the delivery system. For example, different aspects of individuals (food orderer or third party delivery agent), delivery events, and/or other pertinent information may be used for determining rating factors to set or revise premiums for insurance coverage. In another exemplary embodiment, delivery behaviors may provide lower premiums or rewards. For example, behaviors of the food orderer or third party delivery agent can lead to lower premiums for the food orderer or third party delivery agent or rewards such as discounts on insurance premiums or cash rewards.

In another exemplary embodiment, knowledge of accidents and risk may be utilized to augment and/or supplement the delivery system. For example, an insurance company's knowledge of accidents and risks can be used to suggest routes and destinations for the delivery of the food. In another exemplary embodiment, use of food orderer information for prioritization may be utilized to augment and/or supplement the delivery system. For example, insurance companies have a wealth of knowledge about particular customers and customers that share particular characteristics and the insurance companies may use that information to enhance the delivery system.

In another aspect of the disclosure, the delivery system 220 may provide synergies between restaurants, food, and insurance. For example, the delivery system 220 may recommend those restaurants and eating habits or foods that promote a safer individual through recommendations and rewards. The users of those restaurants may then be rewarded when the user orders from those restaurants or orders those kinds of foods. Other synergies may be utilized without departing from this invention.

While the invention has been described with respect to specific examples includes presently preferred modes of carrying out the invention, those skilled in the art will appreciate that there are numerous variations and permutations of the above described systems and techniques that fall within the spirit and scope of the invention.

We claim:

1. A computer-implemented method comprising:
receiving, by a delivery server, a food delivery request, wherein the food delivery request is a food order configured from a person ordering food;
receiving, by the delivery server, a set of historical information about the food orderer to fulfill the food delivery request;
receiving, by the delivery server, a set of historical information about a set of potential delivery agents to fulfill the food delivery request;
providing, by the delivery server, a prioritized ranking of the set of potential delivery agents capable of fulfilling the food delivery; and
determining, by the delivery server, a delivery agent from the set of potential delivery agents by analyzing the food delivery request, the set of historical information about the food orderer and the set of historical information about the set of potential delivery agents.

2. The method of claim 1 further including the step of:
providing, by the delivery server, a reward to one or both of the delivery agent and the person ordering the food.

3. The method of claim 2, wherein the reward is one or more of the following: cash back, a discount for the food delivery request, or a bonus food item for the food delivery request.

4. The method of claim 2, wherein the reward is one or more of the following: a discount of future insurance premiums, increased insurance coverage, or a decreased deductible for insurance coverage.

5. The method of claim 1, wherein the set of historical information includes a set of insurance information.

6. The method of claim 1, wherein the prioritized ranking of the set of potential delivery agents is based on the set of historical information about the potential delivery agents to select a delivery route that is a safest route based on previous accidents and previous claims in the set of historical information.

7. The method of claim 1 further including the step of:
utilizing, by the delivery server, the set of historical information and determining a safe route based on the set of historical information of the delivery for the delivery agent.

8. A computer-implemented method comprising:
receiving, by a delivery server, a food delivery request, wherein the food delivery request is a food order configured from a person ordering food;
receiving, by the delivery server, a set of insurance information about the food orderer and a set of potential delivery agents to fulfill the food delivery request;
providing, by the delivery server, a prioritized ranking of the set of potential delivery agents capable of fulfilling the food delivery;
determining, by the delivery server, a delivery agent from the set of potential delivery agents by analyzing the food delivery request, the set of insurance information about the food orderer and the set of insurance information about the set of potential delivery agents;
utilizing, by the delivery server, the set of insurance information and determining a safe route based on the set of insurance information of the delivery for the delivery agent; and
providing, by the delivery server, a reward to one or both of the delivery agent and the person ordering the food.

9. The method of claim 8, wherein the reward is one or more of the following: cash back, a discount for the food delivery request, or a bonus food item for the food delivery request.

10. The method of claim 8, wherein the reward is one or more of the following: a discount of future insurance premiums for the delivery agent, increased insurance coverage for the delivery agent, or a decreased deductible for insurance coverage for the delivery agent.

11. The method of claim 8, wherein the reward is one or more of the following: a discount of future insurance premiums for the person ordering the food, increased insurance coverage for the person ordering the food, or a decreased deductible for insurance coverage for the person ordering the food.

12. The method of claim 8, wherein the prioritized ranking of the set of potential delivery agents is based on the set of insurance information about the potential delivery agents to select a delivery route that is a safest route based on previous accidents and previous claims in the set of insurance information.

13. The method of claim 8, wherein the set of potential delivery agents is included in a pre-determined list of delivery agents willing to deliver food from a restaurant.

14. One or more non-transitory computer readable media storing computer readable instructions that, when executed, cause an apparatus to:
(a) receive, by a delivery server, a food delivery request, wherein the food delivery request is a food order derived from a person ordering food;
(b) receive, by the delivery server, a set of insurance information about the food orderer to fulfill the food delivery request;
(c) receive, by the delivery server, a set of insurance information about a set of potential delivery agents to fulfill the food delivery request;
(d) provide, by the delivery server, a prioritized ranking of the set of potential delivery agents capable of fulfilling the food delivery; and
(e) determine, by the delivery server, a delivery agent from the set of potential delivery agents by analyzing the food delivery request, the set of insurance information about the food orderer and the set of insurance information about the set of potential delivery agents.

15. The one or more non-transitory computer readable media of claim 14 further including the instructions of:
(f) providing, by the delivery server, a reward to one or both of the delivery agent and the person ordering the food.

16. The one or more non-transitory computer readable media of claim 15, wherein the reward is one or more of the following: cash back, a discount for the food delivery request, or a bonus food item for the food delivery request.

17. The one or more non-transitory computer readable media of claim 15, wherein the reward is one or more of the following: a discount of future insurance premiums for the delivery agent, increased insurance coverage for the delivery agent, or a decreased deductible for insurance coverage for the delivery agent.

18. The one or more non-transitory computer readable media of claim 15, wherein the reward is one or more of the following: a discount of future insurance premiums for the person ordering the food, increased insurance coverage for the person ordering the food, or a decreased deductible for insurance coverage for the person ordering the food.

19. The one or more non-transitory computer readable media of claim 14, wherein the prioritized ranking of the set of potential delivery agents is based on the insurance information about the potential delivery agents to select a delivery route that is a safest route based on previous accidents and previous claims in the set of insurance information.

20. The one or more non-transitory computer readable media of claim 14 further including the instructions of:
(f) utilizing, by the delivery server, a set of historical information and the set of insurance information and determining a safe route based on the set of historical information and the set of insurance information of the delivery for the delivery agent.
